(19) United States
(12) Patent Application Publication
(10) Pub. No.: US 2025/0326651 A1
(43) Pub. Date: Oct. 23, 2025

(54) METHODS FOR MAKING ZEOLITE-Y PARTICLES

(71) Applicant: Saudi Arabian Oil Company, Dhahran (SA)

(72) Inventors: Faisal Alotaibi, Al-Khobar (SA); Lianhui Ding, Dhahran (SA); Mohammad F. Aljishi, Dhahran (SA)

(73) Assignee: Saudi Arabian Oil Company, Dhahran (SA)

(21) Appl. No.: 18/638,105

(22) Filed: Apr. 17, 2024

(51) Int. Cl. C01B 39/20; C01B 33/26

(52) U.S. Cl. CPC C01B 39/205; C01B 33/2853; C01P 2004/01

(57) ABSTRACT

Zeolite-Y particles may be made by a method that includes forming a zeolite precursor solution that includes an alumina source material, a silica source material, and a solvent. The alumina source material may include aluminum nitrate, aluminum sulfate, or both. The method may further include heating the zeolite precursor solution at a temperature of from 50° C. to 120° C. to form an intermediate mixture, and heating the intermediate mixture at a temperature of from 80° C. to 120° C. to form the zeolite-Y particles. The zeolite-Y particles may have a silica to alumina molar ratio of at least 2.

### FIELD

The embodiments described herein generally relate to porous materials and, more particularly, to zeolites.

### BACKGROUND

Materials that include pores, such as zeolites, may be utilized in many petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types, and where specific zeolitic materials may be more specifically identified by various names such as ZSM-5 or zeolite-Y.

Zeolite-containing catalysts and adsorbents have widespread uses in many diverse industries. Exemplary industries include the petrochemical industry in refinery, gas separation, and carbon dioxide separation and capture processes. In the petroleum industry, for example, zeolite containing catalysts may be included in processes such as fluid catalytic cracking (FCC) and hydrocracking to catalyze reactions such as hydrogenation, dehydrogenation, isomerization, alkylation, and cracking, for example. Zeolite containing adsorbents may be utilized in the separation of paraffins or aromatic isomers, and in drying processes to remove water and other impurities from hydrocarbon streams.

### SUMMARY

It may be desirable to fabricate zeolite-Y particles that have relatively high Si to Al ratios for certain uses in industry. Embodiments of the present disclosure are directed to methods of making zeolite-Y particles that have relatively high Si to Al ratios. It has been discovered that utilizing particular aluminum source materials may affect Si to Al ratio of the zeolite-Y particle. In particular, utilizing of aluminum nitrate and/or aluminum sulfate as the alumina sources during zeolite synthesis may cause relatively high silica to alumina ratios, such as at least 2. Such embodiments may also be beneficial in selectively controlling characteristics of the zeolite such as, without limitation, the porosity of the zeolite-Y and size of the zeolite-Y particles, both of which may affect catalytic functionality for hydrocracking.

According to one or more embodiments, zeolite-Y particles may be made by a method that comprises forming a zeolite precursor solution comprising an alumina source material, a silica source material, and a solvent. The alumina source material may comprise aluminum nitrate, aluminum sulfate, or both. The method may further comprise heating the zeolite precursor solution at a temperature of from 50° C. to 120° C. to form an intermediate mixture, and heating the intermediate mixture at a temperature of from 80° C. to 120° C. to form the zeolite-Y particles. The zeolite-Y particles may have a silica to alumina molar ratio of at least 2.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description of specific embodiments of the present disclosure can be best understood when read in conjunction with the following drawings in which:

FIG. 1 depicts a micrograph of zeolite-Y particles, according to one or more embodiments described herein;

FIG. 2 graphically depicts the size distribution of zeolite-Y particles, according to one or more embodiments described herein;

FIG. 3 depicts a micrograph of zeolite-Y particles, according to one or more embodiments described herein; and

FIG. 4 graphically depicts the size distribution of zeolite-Y particles, according to one or more embodiments described herein;

FIG. 5, depicts a micrograph of zeolite-Y particles synthesized using a comparative synthetic method;

FIG. 6, graphically depicts the size distribution of zeolite-Y particles synthesized using a comparative synthetic method; and

FIG. 7, depicts a micrograph of zeolite-Y particles synthesized using a comparative synthetic method.

Reference will now be made in greater detail to various embodiments, some embodiments of which are illustrated in the accompanying drawings.

### DETAILED DESCRIPTION

One or more embodiments presently described herein are directed to methods of making zeolite-Y particles. The methods are described in detail hereinafter, along with properties and physical characteristics of the formed zeolite-Y particles. As is described herein, the use of aluminum nitrate and/or aluminum sulfate as an aluminum source may promote desired silica to alumina ratios in the zeolite-Y and affect particle size and porosity. The methods described herein may be utilized, according to embodiments, with organic structure-directing agents or without organic structure-directing agents.

As used throughout this disclosure, “zeolites” or “zeolite materials” generally refer to micropore-containing inorganic materials with regular intra-crystalline cavities and channels of molecular dimension, as would be understood by those skilled in the art. Zeolites generally comprise a crystalline structure, as opposed to an amorphous structure. The microporous structure of zeolites may render large surface areas and desirable size-/shape-selectivity, which may be advantageous for catalysis. Accordingly, zeolites may be utilized in many petrochemical industrial applications, such as, for instance, reactions that convert hydrocarbons or other reactants from feed chemicals to product chemicals by cracking.

Generally, zeolites may be characterized by a microporous framework type, which defines their microporous structure. Framework types are described in, for instance, “Atlas of Zeolite Framework Types” by Christian Baerlocher et al., Sixth Revised Edition, published by Elsevier, 2007, the teachings of which are incorporated by reference herein.

As described herein, the zeolites formed are zeolite-Y. Zeolite-Y generally comprises an FAU framework type. Zeolite-Y described herein may be characterized, in some embodiments, as ultra-stable zeolite-Y (USY), where an USY is a type of zeolite-Y. As used herein, “zeolite-Y” and “USY” may refer to a zeolites having a FAU framework type according to the IZA zeolite nomenclature and consisting majorly of silica and alumina, as would be understood by one skilled in the art.

According to the methods for making zeolite-Y particles described herein, in general, a zeolite precursor solution may be formed and the zeolite precursor solution may be heated in a first heating step to form an intermediate mixture. Another heating process may then be performed on the intermediate mixture to form the zeolite-Y particles.

As described hereinabove, in one or more embodiments, in an initial step, a zeolite precursor solution is formed. Generally, zeolite precursor solutions may refer to those that include the materials that will form the zeolite, such as silicon, aluminum, and oxygen atoms. Zeolite precursor solutions may include a solvent and at least an alumina source material and a silica source material. The zeolite precursor solution may further comprise a basic compound, as described herein. The solvent may be water, but other solvents are not necessarily excluded from the scope of the presently disclosed methods.

In one or more embodiments, the alumina source material comprises or consists of aluminum nitrate, aluminum sulfate, or both. In some embodiments, sodium aluminate may not be used as an alumina source material. In some additional embodiments, the alumina source material may not be aluminum isopropoxide. Without being bound by theory, it is believed that the use of aluminum nitrate and/or aluminum sulfate as the alumina source may allow for control of silica to alumina ratio in the zeolite-Y, surface area, porosity, and yield. For example, as compared with the use of sodium aluminate as an alumina source, the use of aluminum nitrate and/or aluminum sulfate may increase the silica to alumina ratio, solid product yield, pore size, and/or pore volume. Increased porosity may benefit catalytic activity, and product yield increase is also greatly desirable from a commercial standpoint.

According to embodiments, without limitation, the silica source material may comprise one or more of colloidal silica, fumed silica, or tetraethyl orthosilicate (TEOS), or Na₂SiO₃.

It should be understood that molecules of source materials may disassociate in solution, and that the zeolite precursor solution comprising the alumina source material and the silica source material may refer to a zeolite precursor solution comprising the initial molecular compounds of the source materials or solutions comprising the disassociated components of these molecules. The basic compound may be chosen from NaOH, KOH, Mg(OH)₂, and the basic compound composition is not necessarily limited.

According to one or more embodiments, the zeolite precursor solution may generally be prepared by mixing the alumina source material and the silica source material into a solvent to form a mixture. For example, the alumina source material may be mixed into a solvent, the silica source material may be mixed into another solvent, and these two mixtures may be combined. The ordering of the mixing of the alumina source material and the silica source material into the solvent is not necessarily limited. Similarly, a basic compound may be mixed into the solution that includes the alumina source material and silica source material, or may be added already mixed with the solvent.

According to one or more embodiments, the mixture that includes the alumina source material and silica source material (and sometimes a basic compound) may be aged to form the zeolite precursor solution. Aging may be for a period of time of at least 10 hours, such as from 10 hours to 48 hours, from 10 hours to 30 hours, or from 15 hours to 25 hours. The aging may include agitating the mixture, such as stirring the mixture. In some embodiments, the aging may be at an elevated temperature, such as about 30° C., but in other embodiments, the aging may be at ambient temperature such as about 25° C. Without being bound by theory, while it is not believed that the overall chemical composition substantially changes in the mixture during aging, it is believed that aging may form zeolite nuclei from which zeolitic particles may be formed in downstream steps by crystallization. In general, final crystal sizes may be smaller when more nuclei are formed during aging, and relatively small crystal size and particle size may be desired.

In one or more embodiments, the molar ratio of components in the zeolite precursor solution may be 8-12 Na₂O: 1 Al₂O₃: 6-20 SiO₂: 200-400 H₂O. Molar ratios of any two of these components are contemplated herein based on the described molar ratio of Na₂O, alumina, silica, and water.

In some embodiments, the zeolite precursor solution may further comprise an organic structure-directing agent (sometimes referred to in industry as a “templating agent”) As described herein, an organic structure-directing agent may refer to a compound or compounds that promote the formation of the zeolitic framework. Such organic structure-directing agents may self-assemble in a solution to form an ordered meso-structure from which a zeolite may crystallize around the templating agent structure to form a zeolite with the desired framework. According to some embodiments, the templating agent may be chosen from tetramethylammonium hydroxide, tetraethylammonium hydroxide, tetrapropylammonium hydroxide, tetraethylammonium bromide, and tetrapropylammonium bromide.

In some embodiments, the method of making zeolite-Y particles may exclude the use of an organic structure-directing agent. It is contemplated that it may be beneficial to utilize embodiments with no organic structure-directing agent to reduce cost and overall simplify the procedure without substantially losing desired properties when utilizing organic structure-directing agents.

In embodiments utilizing a templating agent, forming the zeolite precursor may comprise forming a first solution and a second solution. The first solution may comprise at least the silica source material and a first solvent, and the second solution may comprise at least the alumina source material and a second solvent. The first solution may be formed by a process that comprises dissolving the silica source material into the first solution, and the second solution may be formed by a process that comprises dissolving the alumina source material into the second solution. It should be understood that molecules of source materials may disassociate in solution, and that the first solution and the second solution comprising an alumina source material or a silica source material may refer to the first or second solutions comprising the initial molecules of the source materials or disassociated components of these molecules. Without limitation, the first solvent and/or the second solvent may be water.

In one or more embodiments, the first solution, the second solution, or both may further comprise a basic compound. The basic compound may be chosen from NaOH, KOH, Mg(OH)₂, and the basic compound composition is not necessarily limited. It is believed that the presence of a basic compound, particularly in the second solution (including the alumina source material) may enhance the ability of the alumina source material to more fully dissolve into the second solvent.

In one or more embodiments, the first solution may be combined with the second solution to form the initial zeolite precursor solution. Combining the first solution with the second solution may be by mixing together in the same container.

Without being bound by theory, it is believed that by forming separate solutions for the silica source material and the alumina source material, and then mixing the two solutions, may improve the uniformity of the combined mixture when compared to mixtures formed without using separate solutions for the silica source material and the alumina source material. This solution uniformity may beneficially affect the uniformity of zeolite nuclei formed from the solution, which may improve the uniformity of the zeolite-Y particles formed from the methods of the present disclosure when compared to zeolite-Y particles formed using methods that do not form separate solutions for the alumina source material and the silica source material.

Following the forming of the initial zeolite precursor solution, the initial zeolite precursor solution may be heated. According to one or more embodiments, the initial zeolite precursor solution may be heated at a temperature of at least 50° C., such as from 50° C. to 120° C. For example, the heating may be at a temperature of from 50° C. to 60° C., from 60° C. to 70° C., from 70° C. to 80° C., from 80° C. to 90° C., from 90° C. to 100° C., from 100° C. to 110° C., from 110° C. to 120° C., or any combination of one or more of these ranges. In one or more embodiments the heating may be for a time period of from 12 hours to 24 hours, such as from 12 hours to 14 hours, from 14 hours to 16 hours, from 16 hours to 18 hours, from 18 hours to 20 hours, from 20 hours to 22 hours, from 22 hours to 24 hours, or any combination of one or more of these ranges. Without being bound by theory, it is believed that during this heating step precursor zeolite nuclei may form.

Following the heating of the zeolite precursor solution to form the intermediate mixture, the intermediate mixture may be heated at a temperature of from 80° C. to 120° C. For example, the intermediate mixture may be heated at a temperature of from 80° C. to 120° C., such as from 80° C. to 85° C., from 85° C. to 90° C., from 90° C. to 95° C., from 95° C. to 100° C., from 100° C. to 105° C., from 105° C. to 110° C., from 110° C. to 115° C., from 115° C. to 120° C., or any combination of one or more of these ranges. In one or more embodiments, the intermediate mixture may be heated for a time period of from 12 hours to 24 hours, such as from 12 hours to 14 hours, from 14 hours to 16 hours, from 16 hours to 18 hours, from 18 hours to 20 hours, from 20 hours to 22 hours, from 22 hours to 24 hours, or any combination of one or more of these ranges.

In one or more embodiments, the heating of the intermediate mixture forms the crystalized zeolite-Y particles in a residual liquid solution. In one or more embodiments, following the formation of the zeolite-Y particles in residual liquid solution, the zeolite-Y particles are separated from the residual liquid solution. Separation may be by a wide variety of techniques, and generally phase separation techniques may be suitable since the zeolite-Y particles are solids and the residual liquid solution is a liquid. For example, centrifugation may be utilized to separate the zeolite-Y particles from the residual liquid solution. Separation of the zeolite-Y particles may be complete or incomplete where, for example, some small amount of zeolite-Y particles remain in the residual liquid solution, but this is not desirably the case.

Following separation of the zeolite-Y particles from the residual liquid solution, the zeolite-Y particles may be washed and/or dried. Washing may be with water, and may be conducted until the pH of the zeolite-Y particles is from about 8 to 9. Drying may be by presence in ambient conditions or by heating, such as relatively low temperature heating. Following drying, the zeolite-Y particles may be calcinated by exposure to heat. The calcination may be performed by exposure to temperatures of from 300° C. to 500° C. for 4 to 10 hours.

According to one or more embodiments, the zeolites may be aluminosilicates, meaning that they have a crystalline structure that include silica and alumina. The molar ratio of silica to alumina of a zeolite can affect the properties of the zeolite when the zeolite is used in a chemical reaction. For example, a zeolite with a relatively high silica to alumina molar ratio may be more selective towards the production of light olefins when used as a catalyst to process a hydrocarbon feedstock. In one or more embodiments the zeolite-Y particles may have a silica to alumina molar ratio of greater than 2, such as from 2 to 9. For example, the zeolite-Y particles may have a silica to alumina molar ratio of from 2 to 3, from 3 to 4, from 4 to 5, from 5 to 6, from 6 to 7, from 7 to 8, from 8 to 9, or any combination of one or more of these ranges. As would be appreciated by those skilled in the art, the silica to alumina ratio accounts for oxygen atoms in these compounds, whereas a Si: Al ratio would not and would, accordingly, be different.

As described herein, the zeolite-Y may be formed as particles. The particles may be shaped particles, such as spheres, or may be inconsistent in shape or otherwise globular in shape, and shape of the particles is not necessarily limited in embodiments described herein. As described herein, the size of a particle refers to the maximum length of a particle from one side to another, measured along the longest distance of the particle. For example, a spherically shaped particle has a size equal to its diameter, or a rectangular prism shaped particle has a maximum length equal to the hypotenuse stretching from opposite corners. Particle size may be measured by a variety of known techniques such as laser diffraction analysis or microscopy. In one or more embodiments, the zeolite-Y particles may be nano-sized meaning that they have an average particle size of less than 1 micron. In some embodiments, the zeolite-Y particles may have an average diameter of from less than 800 nm, such as, from 500 nm to 750 nm. For example, the zeolite-Y particles may have an average diameter of from 500 nm to 550 nm, from 550 nm to 600 nm, from 600 nm to 650 nm, from 650 nm to 700 nm, from 700 nm to 750, or any combination of one or more of these ranges.

In one or more embodiments, the zeolite-Y particles described may include, in addition to micropores (present in the microstructure of a zeolite), mesopores, and the zeolite-Y particles may be mesoporous by having an average pore size of greater than 2 nm and less than or equal to 50 nm. Unless otherwise described herein, the “pore size” of a material refers to the average pore size, but materials may additionally include mesopores having a particular size that is not identical to the average pore size. The average pore size of a material can be measured using BET analysis, as is widely understood to those in the art. According to one or more embodiments, the zeolite-Y particles may have an average pore size of greater than 2 nm, such as from 2 nm to 4 nm, such as from 2 nm to 2.5 nm, from 2.5 nm to 3 nm, from 3 nm to 3.5 nm, from 3.5 nm to 4 nm, or any combination of one or more of these ranges.

In one or more embodiments, the zeolite-Y particles may have an average micropore volume and/or an average mesopore volume, where the total pore volume is the sum of these two. The mesopore and micropore volumes may be calculated according to the Barrett-Joiner-Halenda (BJH) method of determining mesopore volume known to one having skill in the art. Details regarding the t-plot method and the BJH method of calculating micropore volume and mesopore volume respectively are provided in Galarneau et al., “Validity of the t-plot Method to Assess Microporosity in Hierarchical Micro/Mesoporous Materials”, Langmuir 2014, 30, 13266-13274, for example. In one or more embodiments, the zeolite-Y particles may have a total pore volume of from 0.4 ml/g to 1.0 ml/g, such as from 0.4 ml/g to 0.45 ml/g, from 0.45 ml/g to 0.5 ml/g, from 0.5 ml/g to 0.55 ml/g, from 0.55 ml/g to 0.6 ml/g, from 0.6 ml/g to 0.65 ml/g, from 0.65 ml/g to 0.7 ml/g, from 0.7 ml/g to 0.75 ml/g, from 0.75 ml/g to 0.8 ml/g, from 0.8 ml/g to 0.85 ml/g, from 0.85 ml/g to 0.9 ml/g, from 0.9 ml/g to 0.95 ml/g, from 0.95 ml/g to 1.0 ml/g, or any combination of one or more of these ranges.

In one or more embodiments, the zeolite-Y particles may have an average surface area of at least 600 m²/g, such as at least 650 m²/g, at least 700 m²/g, at least 750 m²/g, at least 800 m²/g, or even at least 850 m²/g, as determined through the Brunauer-Emmett-Teller (BET) method (average BET surface area).

As described herein, crystallinity is a measurement of the degree of structural order in a solid. A more crystalline solid will have its atoms and molecules arranged in a more regular and periodic manner than a less crystalline solid. Crystallinity is typically determined by x-ray diffraction. A particular diffraction peak can be selected and its intensity normalized. Zeolites can be analyzed and the diffraction intensity normalized against the standard producing a relative crystallinity based on a standard zeolite structure. In one or more embodiments, the zeolite-Y particles may have a relative crystallinity based on the crystallinity of CBV-100, available from Zeolyst International, of greater than 80%.

The zeolite-Y particles described herein may be utilized alone or in combination with other materials as catalyst used in hydrocracking processes. Such a catalyst may have at least two functions: cracking of high molecular weight hydrocarbon and hydrogenating the unsaturated molecules. However, the relatively small pore size (e.g. average pore size less than 2 nm) of most conventional zeolites Y materials in hydrocracking catalysts generally does not favor the transport of large molecules in heavy oil fractions to diffuse into the active sites located inside the zeolite. This may cause low activity, and a possible deactivation of the catalyst. Additionally, the poor diffusion efficiency of bulky molecules can be avoided by reduced zeolite particle size due to increased external surface area and shortened diffusion path of the molecules. However, the relatively small particle size of the presently disclosed zeolite-Y materials may enable for better access of reactive molecules to catalytic sites.

### EXAMPLES

The various embodiments of methods described will be further clarified by the following examples. The examples are illustrative in nature, and should not be to limit the subject matter of the present disclosure.

### Comparative Example A

First 68.0 g of sodium hydroxide (NaOH) was dissolved in 392.4 g of water in a glass bottle. To this mixture 16.4 g of sodium aluminate (NaAlO₂) and 210 g of 40 wt. % colloidal silica was added and stirred for 1 hour. The mixture was then stirred and aged at 30° C. for 20 hours. The resulting hydrogel mixture was next transferred to a different vessel for autoclaving at 60° C. for 12 hours for first stage crystallization, then temperature was increased to 100° C. for 12 hours for second stage crystallization in an autoclave. The obtained mixture was filtrated and washed with water until its pH reached between 8 and 9. The resulting solid product was dried at 110° C. for 24 hours and then calcinated at 500° C. for 4 hours (2° C./min ramp).

### Example 1

In Example 1 two different alumina sources were used to form zeolite-Y particles Zeolite-Y particles were formed using aluminum sulfate without a templating agent by dissolving 7.6 g of sodium hydroxide (NaOH) in 36 g of water in a glass bottle. To this mixture 6.66 g of aluminum sulfate (Al₂(SO₄)₃·18H₂O) and 21 g of 40 wt. % colloidal silica was added and stirred for 1 hour. The mixture was then stirred and aged at 30° C. for 20 hours. The resulting hydrogel mixture was autoclaved at 60° C. for 12 hours for first stage crystallization, then temperature was increased to 100° C. for 12 hours for second stage crystallization in an autoclave. The obtained mixture was filtrated and washed with water until its pH reached between 8 and 9. The resulting solid product was dried at 110° C. for 24 hours and then calcinated at 500° C. for 4 hours (2° C./min ramp). Zeolite-Y particles were formed using aluminum nitrate without a templating agent in an identical process except 7.5 g of aluminum nitrate (Al(NO₃)₃·9H₂O) was used instead of aluminum sulfate.

TABLE 1
Properties of Zeolites Produced

| | Sample | | |
|---|---|---|---|
| | EX-1A | EX-1B | CE-A |
| | Alumina Source | | |
| | Aluminum | Aluminum | Sodium |
| | Sulfate | Nitrate | Aluminate |
| Average particle sizes, nm | 739 | 611 | 200 |
| Crystallinity % | 92 | 92 | 90 |
| Bulk Si/Al, mol/mol | 2.6 | 2.4 | 1.9 |
| Framework Si/Al, mol/mol | 2.1 | 2.3 | 1.6 |
| Total surface area, m²/g | 687 | 636 | 656 |
| Micropore surface area, m²/g | 669 | 596 | 577 |
| Mesopore surface area, m²/g | 19 | 40 | 79 |
| Total pore volume, ml/g | 0.61 | 0.60 | 0.57 |
| Micro pore volume, ml/g | 0.37 | 0.33 | 0.30 |
| Mesopore volume, ml/g | 0.24 | 0.27 | 0.27 |
| Pore size, nm | 3.5 | 3.8 | 3.5 |
| Solid product Yield, grams | 5.6 | 4.8 | N/A |

As shown in Table 1 using aluminum sulfate or aluminum nitrate as the alumina source to form zeolite-Y particles can yield particles with a relatively high Si/Al molar ratio (greater than 2) when compared to zeolite-Y particles formed without using aluminum sulfate or aluminum nitrate as the alumina source.

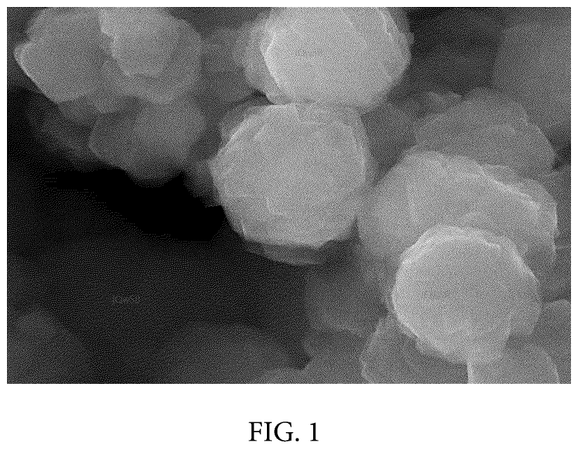

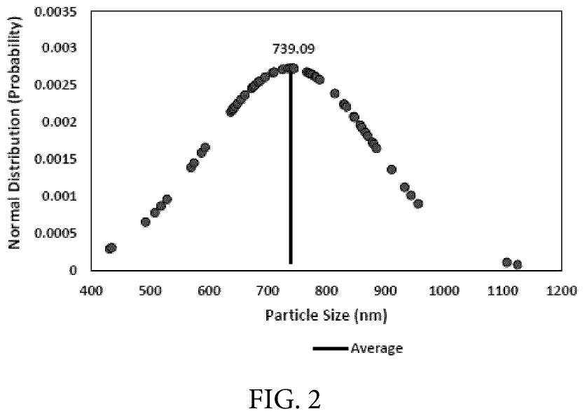

FIG. 1 depicts the zeolite formed from aluminum sulfate without a templating agent and FIG. 2 depicts the distribution of particle sizes in the zeolite-Y particles produced from aluminum sulfate without a templating agent. FIG. 2 shows that the zeolite-Y particles are formed within a narrow range of particle sizes improving the uniformity of the zeolite-Y particles.

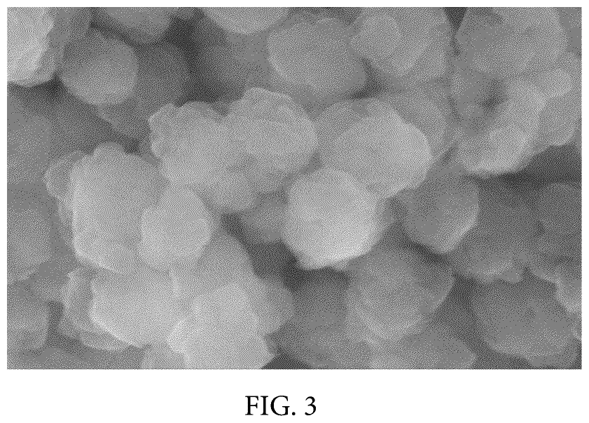

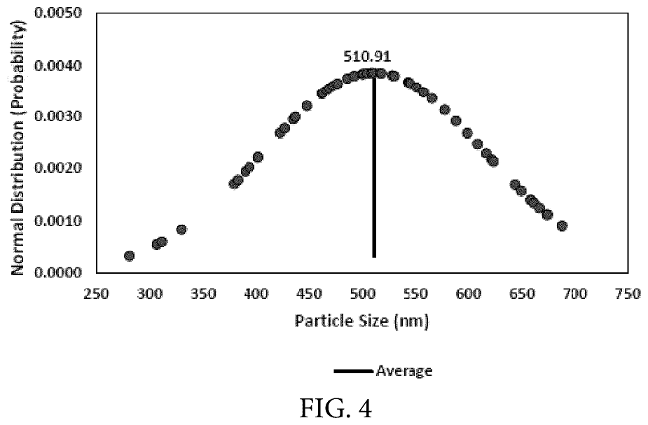

FIG. 3 depicts the zeolite formed from aluminum nitrate without a templating agent and FIG. 4 depicts the distribution of particle sizes in the zeolite-Y particles produced from aluminum nitrate without a templating agent. FIG. 4 shows that the zeolite-Y particles are formed within a narrow range of particle sizes improving the uniformity of the zeolite-Y particles.

### Example 2

In Example 2, two different aluminum sources were used to synthesize zeolite-Y. First, a solution was prepared by adding 7.6 g of NaOH to 16.86 g of water and stirring until dissolved. To this mixture 6.66 g of aluminum sulfate (Al₂(SO₄)₃·18H₂O) was added and stirred for 30 minutes. Then, 12.76 g of tetramethylammonium hydroxide (TMAOH) (25 wt. % in water) was added and stirred into the mixture for 30 minutes. Secondly, to prepare an additional solution TMAOH (25 wt. % in water) and 21.00 g of 40 wt. % colloidal silica were added and mixed together for 30 minutes. Then, the two solutions were slowly added together and stirred for 1 hour. The resulting mixture was then stirred and aged at 30° C. for 20 hours. The resulting hydrogel mixture was crystallized in a first stage at 60° C. for 12 hours, then the temperature was increased to 100° C. for 12 hours at a second stage. The obtained mixture was filtrated and washed with water until its pH reached between 8 and 9. The resulting solid product was then dried at 110° C. for 24 hours and then calcinated at 500° C. for 4 hours (2° C./min).

TABLE 2
Properties Zeolites Produced with a Templating Agent

| | Alumina Source | | |
|---|---|---|---|
| | Aluminum | Aluminum | Sodium |
| | Sulfate | Nitrate | Aluminate |
| Average particle sizes, nm | 383 | 300 | 66.2 |
| Crystallinity % | 89 | 81 | 90.0 |
| Bulk Si/Al, mol/mol | 1.9 | 1.9 | 1.5 |
| Framework Si/Al, mol/mol | 1.7 | 1.7 | 1.5 |
| Total surface area, m2/g | 590 | 587 | 614 |
| Micropore surface area, m2/g | 537 | 532 | 497 |
| Mesopore surface area, m²/g | 66.0 | 117.0 | 117.0 |
| Total pore volume, ml/g | 0.720 | 1.10 | 1.10 |
| Micro pore volume, ml/g | 0.300 | 0.280 | 0.280 |
| Mesopore volume, ml/g | 0.420 | 0.820 | 0.820 |
| Pore size, nm | 4.60 | 7.14 | 7.14 |
| Solid product Yield, wt % | 43.9 | 43.9 | 43.9 |
| TMAOH/SiO₂, Molar ratio | 0.5 | 0.5 | — |

As shown in Table 2, using aluminum sulfate or aluminum nitrate as the alumina source to form zeolite-Y particles can yield particles with a relatively high Si/Al molar ratio when compared to zeolite-Y particles formed without using aluminum sulfate or aluminum nitrate as the alumina source.

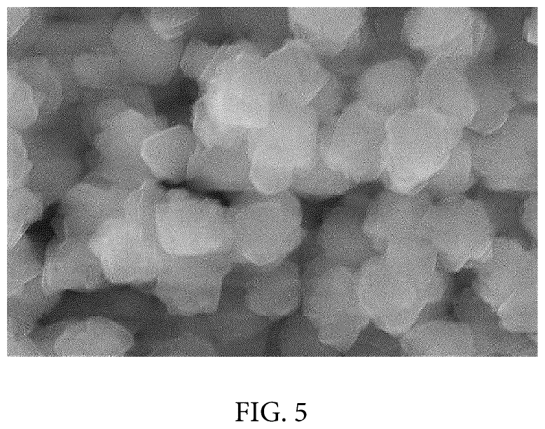

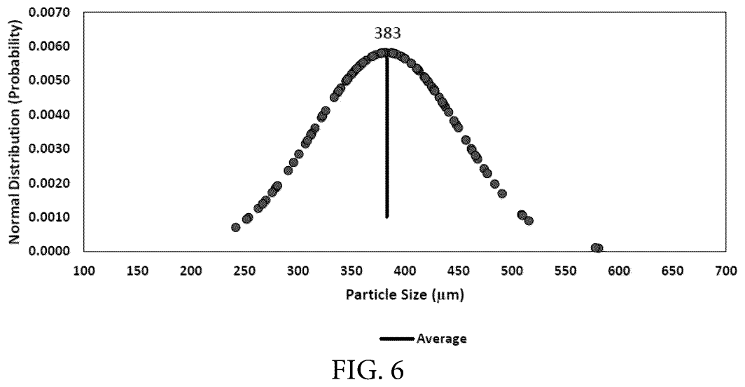

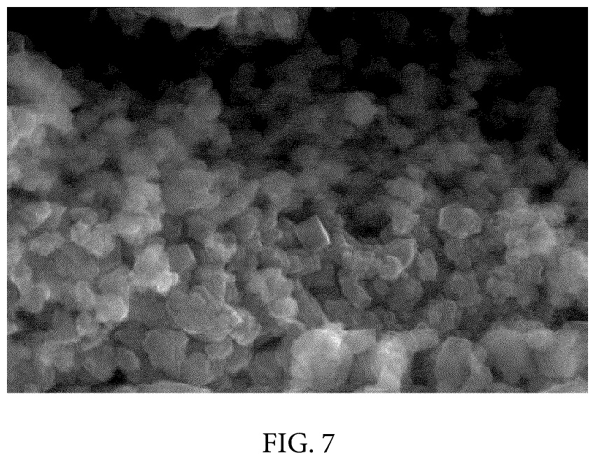

FIG. 5 depicts the zeolite formed from aluminum sulfate with a templating agent and FIG. 6 depicts the distribution of particle sizes in the zeolite-Y particles produced from aluminum sulfate with a templating agent. FIG. 7 depicts the zeolite formed from aluminum nitrate with a templating agent.

This disclosure includes numerous technical aspects, several of which are disclosed hereinbelow.
Aspect 1. A method for making zeolite-Y particles, the method comprising: forming a zeolite precursor solution comprising an alumina source material and a silica source material, wherein the alumina source material and a silica source material are in a solvent, and wherein the alumina source material comprises aluminum nitrate, aluminum sulfate, or both; heating the zeolite precursor solution at a temperature of from 50° C. to 120° C. to form an intermediate mixture; and heating the intermediate mixture at a temperature of from 80° C. to 120° C. to form the zeolite-Y particles, wherein the zeolite-Y particles have a silica to alumina molar ratio of at least
Aspect 2. The method of any other aspect or combination of aspects, wherein the alumina source material comprises aluminum nitrate.
Aspect 3. The method of any other aspect or combination of aspects, wherein the alumina source material comprises aluminum sulfate.
Aspect 4. The method of any other aspect or combination of aspects, wherein the alumina source material consists of aluminum nitrate.
Aspect 5. The method of any other aspect or combination of aspects, wherein the alumina source material consists of aluminum sulfate.
Aspect 6. The method of any other aspect or combination of aspects, wherein the zeolite-Y particles have a molar ratio of silica to alumina of from 2 to 9.
Aspect 7. The method of any other aspect or combination of aspects, wherein the silica source material is chosen from one or more of colloidal silica, fumed silica, tetraethyl orthosilicate, or Na₂SiO₄.
Aspect 8. The method of any other aspect or combination of aspects, wherein the heating of the zeolite precursor solution is for a time period of from 12 hours to 24 hours.
Aspect 9. The method of any other aspect or combination of aspects, wherein the heating of the zeolite precursor solution is at a temperature of from 50° C. to 70° C.
Aspect 10. The method of any other aspect or combination of aspects, wherein the heating of the intermediate mixture is for a time period of from 12 hours to 24 hours.
Aspect 11. The method of any other aspect or combination of aspects, wherein the heating of the intermediate mixture is at a temperature of from 90° C. to 110° C.
Aspect 12. The method of any other aspect or combination of aspects, wherein the solvent is water.
Aspect 13. The method of any other aspect or combination of aspects, wherein the zeolite precursor solution further comprises a basic compound.
Aspect 14. The method of any other aspect or combination of aspects, wherein the basic compound is NaOH.
Aspect 15. The method of any other aspect or combination of aspects, wherein the method does not utilize an organic structure-directing agent.
Aspect 16. The method of any other aspect or combination of aspects, wherein the zeolite precursor solution comprises an organic structure-directing agent.
Aspect 17. The method of aspect 16, wherein the organic structure-directing agent is chosen from tetramethylammonium hydroxide, tetraethylammonium hydroxide, tetrapropylammonium hydroxide, tetraethylammonium bromide, or tetrapropylammonium bromide.
Aspect 18. The method of aspect 16, wherein the organic structure-directing agent is tetramethylammonium hydroxide.
Aspect 19. The method of any other aspect or combination of aspects, wherein forming zeolite precursor solution comprises: forming a mixture comprising the solvent, a basic compound, the silica source material, and the alumina source material; and aging the mixture by stirring the mixture for at least 10 hours.
Aspect 20. The method of any other aspect or combination of aspects, further comprising: washing the zeolite-Y particles; drying the zeolite-Y particles; and calcinating the zeolite-Y particles.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

What is claimed is:

1. A method for making zeolite-Y particles, the method comprising:
forming a zeolite precursor solution comprising an alumina source material, a silica source material, and a solvent, wherein the alumina source material comprises aluminum nitrate, aluminum sulfate, or both;
heating the zeolite precursor solution at a temperature of from 50° C. to 120° C. to form an intermediate mixture; and
heating the intermediate mixture at a temperature of from 80° C. to 120° C. to form the zeolite-Y particles, wherein the zeolite-Y particles have a silica to alumina molar ratio of at least 2.

2. The method of claim 1, wherein the alumina source material comprises aluminum nitrate.

3. The method of claim 1, wherein the alumina source material comprises aluminum sulfate.

4. The method of claim 1, wherein the alumina source material consists of aluminum nitrate.

5. The method of claim 1, wherein the alumina source material consists of aluminum sulfate.

6. The method of claim 1, wherein the zeolite-Y particles have a molar ratio of silica to alumina of from 2 to 9.

7. The method of claim 1, wherein the silica source material is chosen from one or more of colloidal silica, fumed silica, tetraethyl orthosilicate, or Na₂SiO₄.

8. The method of claim 1, wherein the heating of the zeolite precursor solution is for a time period of from 12 hours to 24 hours.

9. The method of claim 1, wherein the heating of the zeolite precursor solution is at a temperature of from 50° C. to 70° C.

10. The method of claim 1, wherein the heating of the intermediate mixture is for a time period of from 12 hours to 24 hours.

11. The method of claim 1, wherein the heating of the intermediate mixture is at a temperature of from 90° C. to 110° C.

12. The method of claim 1, wherein the solvent is water.

13. The method of claim 10, wherein the zeolite precursor solution further comprises a basic compound.

14. The method of claim 13, wherein the basic compound is NaOH.

15. The method of claim 1, wherein the method does not utilize an organic structure-directing agent.

16. The method of claim 1, wherein the zeolite precursor solution comprises an organic structure-directing agent.

17. The method of claim 16, wherein the organic structure-directing agent is chosen from tetramethylammonium hydroxide, tetraethylammonium hydroxide, tetrapropylammonium hydroxide, tetraethylammonium bromide, or tetrapropylammonium bromide.

18. The method of claim 16, wherein the organic structure-directing agent is tetramethylammonium hydroxide.

19. The method of claim 1, wherein forming zeolite precursor solution comprises:
forming a mixture comprising the solvent, a basic compound, the silica source material, and the alumina source material; and
aging the mixture by stirring the mixture for at least 10 hours.

20. The method of claim 1, further comprising:
washing the zeolite-Y particles;
drying the zeolite-Y particles; and
calcinating the zeolite-Y particles.
